(19) United States
(12) Patent Application Publication
(10) Pub. No.: US 2025/0096289 A1
(43) Pub. Date: Mar. 20, 2025

(54) FUEL CELL SYSTEM AND METHOD FOR OPERATING A FUEL CELL SYSTEM

(71) Applicant: Robert Bosch GmbH, Stuttgart (DE)

(72) Inventors: Simon Buehler, Stuttgart (DE); Timo Bosch, Renningen (DE); Tobias Falkenau, Esslingen (DE); Christopher Bruns, Sindelfingen (DE)

(21) Appl. No.: 18/728,918

(22) PCT Filed: Jan. 12, 2023
(86) PCT No.: PCT/EP2023/050632

§ 371 Date: Jul. 15, 2024

(30) Foreign Application Priority Data
Jan. 18, 2022 (DE) 10 2022 200 545.7

(51) Int. Cl. H01M 8/0444; H01M 8/04089; H01M 8/04746; H01M 8/04992

(52) U.S. Cl. CPC H01M 8/04447; H01M 8/04097; H01M 8/04776; H01M 8/04992

(57) ABSTRACT

The invention relates to a method (100) for operating a fuel cell system (200), the method (100) comprising: a first determination step (101), in which a hydrogen concentration supplied to a fuel cell stack (203) of the fuel cell system (200) by means of an inlet valve (209) of the fuel cell system (200) is determined, a second determination step (103), in which a nitrogen volume flow flowing through the fuel cell stack (203) is determined, and an adjustment step (105), in which a rotational speed of a recirculation fan (205) of the fuel cell system (200) is adjusted on the basis of the determined hydrogen concentration and the determined nitrogen volume flow. The invention also relates to a fuel cell system (200) and a to computer program product according to the appended claims.

### BACKGROUND

The present invention relates to a method for operating a fuel cell system, a fuel cell system, and a computer program product.

Polymer electrolyte membrane (PEM) fuel cell systems convert hydrogen by means of oxygen into electrical energy, generating waste heat and water.

A PEM fuel cell consists of an anode supplied with hydrogen, a cathode supplied with air, and a polymer electrolyte membrane placed between the two, where air and oxygen are converted into electricity, water, and heat. A plurality of such fuel cells are typically stacked to form a fuel cell stack in order to maximize an electrically generated voltage.

A systemic approach for supplying hydrogen to the PEM anode has been established, in which still hydrogen-rich anode exhaust gas is again supplied to an anode entry by gas conveying units together with fresh hydrogen, which is known as recirculation.

A gas mixture flowing in a fuel cell system is enriched with air by means of a recirculation fan. In this context, the recirculation fan is typically operated at a constant rotational speed.

### SUMMARY

Presented in the context of the invention are a method, a fuel cell system, and a computer program product for operating the fuel cell system. Further features and details of the invention arise from the respective dependent claims, the description, and the drawings. In this context, features and details described in connection with the method according to the invention clearly also apply in connection with the fuel cell system according to the invention as well as the computer program product according to the invention, and respectively vice versa so that, with respect to the disclosure, mutual reference to the individual aspects of the invention is or can always be made.

The invention presented serves to efficiently operate a fuel cell system. In particular, the invention presented serves to dynamically adjust a rotational speed of a recirculation fan of a fuel cell system to an operating situation of the fuel cell system.

Therefore, according to a first aspect of the invention presented, a method for operating a fuel cell system is presented. The method comprises a first determination step, in which a hydrogen concentration supplied to a fuel cell stack of the fuel cell system by means of an inlet valve of the fuel cell system is determined, a second determination step, in which a nitrogen volume flow flowing through the fuel cell stack is determined, and an adjustment step, in which a rotational speed of a recirculation fan of the fuel cell system is adjusted on the basis of the determined hydrogen concentration and the determined nitrogen volume flow.

In the context of the invention presented, the expression “recirculation fan of a fuel cell system” is understood to mean an air conveying unit that supplies air to the fuel cell system by rotating a fan wheel.

The invention presented is based on the principle that a rotational speed of a recirculation fan of a fuel cell system is dynamically adjusted to a current operating situation of the fuel cell system, i.e., to a state of a gas mixture flowing in the fuel cell system in order to, e.g., adjust a specified mixing ratio of gases. For this purpose, the operating situation of the fuel cell system is determined by determining a hydrogen concentration supplied to a fuel cell stack of the fuel cell system by means of an inlet valve of the fuel cell system and a nitrogen volume flow flowing through the fuel cell stack. Based on the hydrogen concentration and the nitrogen volume flow, an amount of air required for an optimal or efficient operation of the fuel cell system can be determined and a corresponding rotational speed can be adjusted at the recirculation fan.

It can be provided that a lambda value of the fuel cell system is determined on the basis of the determined hydrogen concentration and the determined nitrogen volume flow, and the rotational speed of the recirculation fan is adjusted on the basis of the lambda value.

A lambda value mathematically represents an operating state of a fuel cell system using Formula (1):

$${λ}_{H 2} = \dot{{m}_{H 2}} , Stack in / \dot{{m}_{H 2}} , Stack consumed \qquad ( 1 )$$

where “λ_{H2}” indicates a lambda value of the fuel cell system, “\dot{m}_{H2}, Stack in” indicates a volume flow of hydrogen supplied from a fuel cell stack, and “\dot{m}_{H2}, Stack consumed” indicates a volume flow of hydrogen consumed by a fuel cell stack.

It can be further provided that the rotational speed of the recirculation fan is adjusted such that a specified lambda value is adjusted in the fuel cell system.

To adjust a recirculation fan of a fuel cell system, a target variable can be specified such that the rotational speed of the recirculation fan is increased or decreased until λ_{H2}corresponds to the target variable.

It can be further provided that, in the second determination step, the nitrogen volume flow is determined on the basis of a difference in a pressure in the flow direction of the nitrogen volume flow upstream of the fuel cell stack and a pressure in the flow direction flow of the nitrogen volume flow downstream of the fuel cell stack.

On the basis of a pressure difference upstream and downstream of a fuel cell stack of a respective fuel cell system, in conjunction with a known hydrogen concentration that was supplied to the fuel cell stack, the nitrogen volume flow in the fuel cell stack and, as a result, a hydrogen volume flow in the fuel cell stack can be inferred.

It can be further provided that the hydrogen concentration is determined by means of at least a portion of a machine learner without a physical hydrogen concentration sensor.

A hydrogen concentration sensor can be omitted by using a machine learner configured to determine a metered hydrogen concentration based on operational parameters of a particular fuel cell system or adjusted in a fuel cell stack of the fuel cell system.

It can further be provided that the machine learner is trained in a training fuel cell system comprising a hydrogen concentration sensor and is validated based on hydrogen concentration values determined by the hydrogen concentration sensor, whereby the machine learner receives as input signals at least one operating parameter of a recirculation fan of the training fuel cell system and a state parameter of an electrical state of the fuel cell stack of the training fuel cell system.

In the context of the invention presented, the expression “training of a machine learner” is understood to mean a process in which a mathematical model on which the machine learner is based is changed until a specified target, e.g., a minimum deviation between a result of the model and a corresponding measured value of a hydrogen concentration in the training fuel cell system determined by the hydrogen concentration sensor provided according to the invention, is achieved.

In the context of the invention presented herein, the expression “validation of a machine learner” means a process in which initial values determined by the machine learner are compared with measured values.

A machine learner, e.g., an artificial neural network or a support vector machine which is trained under controlled conditions, in particular in a laboratory operation and validated using measured values of a hydrogen concentration in a training fuel cell system determined by means of a hydrogen concentration sensor such that, e.g., a deviation between a value of a hydrogen concentration in the anode circuit of the training fuel cell system determined by the machine learner and a hydrogen concentration measured by means of the hydrogen concentration sensor is minimal or less than a specified threshold value, can be used in a target fuel cell system which does not comprise a hydrogen concentration sensor.

It can further be provided that the at least one portion of the machine learner comprises a data model on which the machine learner is based.

In the target fuel cell system, the machine learner is used to determine a hydrogen concentration in an anode circuit of the target fuel cell system such that a recirculation fan of the target fuel cell system can be adjusted or operated depending on the hydrogen concentration determined by the machine learner. For this purpose, the machine learner can be transferred to the target fuel cell system in whole or in part, e.g. only a data model in which the machine learner is based.

Given that the machine learner was or is trained using hydrogen concentration values determined by means of a hydrogen concentration sensor to interpret respective input values, the machine learner is suitable for operating a target fuel cell system without a hydrogen concentration sensor when it is fully trained. In other words, the trained machine learner comprises a mathematical model of relationships between respective input values and a resulting hydrogen concentration, which comprises all operating conditions of the training fuel cell system performed during the training step and can as a result be used to control or regulate the target fuel cell system without a hydrogen concentration sensor.

In tests, operating parameters of a recirculation fan of a respective fuel cell system, e.g. a power and/or a speed of the recirculation fan, a state parameter of an electrical state of a fuel cell stack, e.g. a voltage and/or an electrical current at the fuel cell stack, a state parameter of a respective fuel cell system, e.g. the system pressure, and a characteristic variable of an amount of hydrogen supplied to the fuel cell stack by means of an inlet valve which can, e.g., be determined by an activity of a pump, an electrical current supplied to the inlet valve, or a volume flow sensor, have proven to be suitable.

According to a second aspect, the invention presented relates to a fuel cell system comprising a control device, the control device being configured to determine a hydrogen concentration supplied to a fuel cell stack of the fuel cell system by means of an inlet valve of the fuel cell system, to determine a nitrogen volume flow flowing through the fuel cell stack, and to adjust a rotational speed of a recirculation fan of the fuel cell system on the basis of the determined hydrogen concentration and the determined nitrogen volume flow.

In a third aspect, the presented invention relates to a computer program product comprising program code means which, when executed on a computer, configures the computer to perform the steps of a possible embodiment of the presented method.

In the context of the invention presented, the expression “computer or control device” is understood to mean a processor, a microcontroller, or any other programmable circuit.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

Shown are:

FIG. 1 one possible embodiment of the method presented,

FIG. 2 one possible embodiment of the presented fuel cell system.

### DETAILED DESCRIPTION

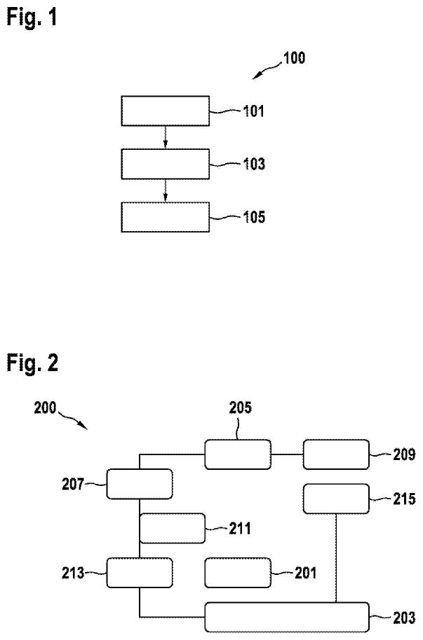

A method 100 for operating a fuel cell system is shown in FIG. 1.

The method 100 comprises a first determination step 101, in which a hydrogen concentration supplied to a fuel cell stack of the fuel cell system by means of an inlet valve of the fuel cell system is determined, a second determination step 103, in which a nitrogen volume flow flowing through the fuel cell stack is determined, and an adjustment step 105, in which a rotational speed of a recirculation fan of the fuel cell system is adjusted on the basis of the determined hydrogen concentration and the determined nitrogen volume flow.

FIG. 2 shows a fuel cell system 200. The fuel cell system 200 comprises a control device 201, a fuel cell stack 203, a recirculation fan 205, a purge valve 207, and an inlet valve 209 for metering fresh hydrogen from a tank and the fuel cell stack 203.

The fuel cell system 200 optionally comprises a water separator 211, a drain valve 213, and a jet pump 215 for adjusting a pressure in the fuel cell stack 203.

The control device 201 is configured to determine a hydrogen concentration supplied to the fuel cell stack 203 by means of an inlet valve 209, to determine a nitrogen flow flowing through the fuel cell stack 203, and to adjust a rotational speed of the recirculation fan 205 on the basis of the determined hydrogen concentration and the determined nitrogen flow.

1. A method (100) for operating a fuel cell system (200), wherein the method (100) comprises:
determining a hydrogen concentration supplied to a fuel cell stack (203) of the fuel cell system (200) by means of an inlet valve (209) of the fuel cell system (200),
determining a nitrogen volume flow flowing through the fuel cell stack (203), and
adjusting a rotational speed of a recirculation fan (205) of the fuel cell system (200) based on the determined hydrogen concentration and the determined nitrogen volume flow.

2. The method (100) according to claim 1, wherein
a lambda value of the fuel cell system (200) is determined based on the determined hydrogen concentration and the determined nitrogen volume flow, and the rotational speed of the recirculation fan (205) is adjusted on the basis of the lambda value.

3. The method (100) according to claim 1, wherein:
the rotational speed of the recirculation fan (205) is adjusted such that a specified lambda value is adjusted in the fuel cell system (200).

4. The method (100) according to claim 1, wherein,
the nitrogen volume flow is determined based on a difference between a pressure in the flow direction of the nitrogen volume flow upstream of the fuel cell stack (203) and a pressure in the flow direction flow of the nitrogen volume flow downstream of the fuel cell stack (203).

5. The method (100) according to claim 1, wherein
the hydrogen concentration is determined via a machine learner without a physical hydrogen concentration sensor.

6. The method (100) according to claim 5, wherein
the machine learner is trained in a training fuel cell system comprising a hydrogen concentration sensor and is validated based on the hydrogen concentration values determined by the hydrogen concentration sensor,
wherein the machine learner receives as input signals an operating parameter of a recirculation fan (205) of the training fuel cell system and a parameter for an electrical state of the fuel cell stack (203) of the training fuel cell system.

7. The method (100) according to claim 5, wherein
the machine learner comprises a data model.

8. A fuel cell system (200) comprising an electronic controller (201),
wherein the electronic controller (201) is configured to:
determine a hydrogen concentration supplied to a fuel cell stack (203) of the fuel cell system (200) by means of an inlet valve (209) of the fuel cell system (200), determine a nitrogen volume flow flowing through the fuel cell stack (203), and adjust a rotational speed of a recirculation fan (205) of the fuel cell system (200) on the basis of the determined hydrogen concentration and the determined nitrogen volume flow.

9. A non-transitory, computer-readable medium containing instructions which, when executed on a computer, configures the computer to determine a hydrogen concentration supplied to a fuel cell stack (203) of the fuel cell system (200) by means of an inlet valve (209) of the fuel cell system (200), determine a nitrogen volume flow flowing through the fuel cell stack (203), and adjust a rotational speed of a recirculation fan (205) of the fuel cell system (200) on the basis of the determined hydrogen concentration and the determined nitrogen volume flow.
